(19) United States
(12) Patent Application Publication
(10) Pub. No.: US 2019/0152041 A1
(43) Pub. Date: May 23, 2019

(54) HAND-OPERATED CRANK HANDLE FOR SEMI-TRAILER TRAP DOORS

(71) Applicant: Richard Sandven, Milan, MN (US)

(72) Inventor: Richard Sandven, Milan, MN (US)

(21) Appl. No.: 16/194,463

(22) Filed: Nov. 19, 2018

Related U.S. Application Data
(60) Provisional application No. 62/588,977, filed on Nov. 21, 2017.

(51) Int. Cl. B25G 1/00

(52) U.S. Cl. CPC B25G 1/007; B60P 1/56

(57) ABSTRACT

A hand-operated crank tool for manually operating hopper trap doors. The crank tool may have a first handle arranged on a first axis, a second handle arranged on a second axis, and a tooling end arranged on a third axis. The crank tool may additionally have a first extension portion extending between the first and second handles and a second extension portion extending between the second handle and the tooling end. The first, second, and third axes may be parallel. In some embodiments, the tooling end may include a socket head, which may be readily removable.

### CROSS-REFERENCE TO RELATED APPLICATIONS

The present disclosure claims priority to Provisional Application No. 62/588,977, entitled “Hand-Operated Crank Handle for Semi-Trailer Trap Doors,” and filed Nov. 21, 2017, the content of which is hereby incorporated by reference herein in its entirety.

### FIELD OF THE INVENTION

The present disclosure relates to novel and advantageous tools. Particularly, the present disclosure relates to novel and advantageous hand-operated crank tools. More particularly, the present disclosure relates to novel and advantageous hand-operated crank tools for use in operating a trap door on a hopper trailer.

### BACKGROUND OF THE INVENTION

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Hoppers, such as grain hoppers, frequently have doors or trap doors arranged at or near a bottom of the hopper. The trap door may be mechanically opened to release the contents from the hopper. Some tractor trailers, trucks, and other vehicles have hoppers arranged at or near a lower surface of the vehicle. In many cases, hopper doors, and particularly hopper doors arranged on tractor trailers and other vehicles, may be difficult to open and/or close due to their location. Similarly, other doors arranged at or near a lower surface of tractor trailers, trucks, and other vehicles may be difficult to open and/or close due to their location. In particular, operators may have difficulty accessing the trap door using manual tools. Automatic or partially automatic trap door mechanisms may be relatively expensive to implement and maintain.

Thus, there is a need in the art for trap door operating mechanisms. Particularly, there is a need in the art for hand-operated tools for opening and closing trap door mechanisms. More particularly, there is a need in the art for hand-operated crank handles for opening and closing semi-trailer trap doors.

### BRIEF SUMMARY OF THE INVENTION

The following presents a simplified summary of one or more embodiments of the present disclosure in order to provide a basic understanding of such embodiments. This summary is not an extensive overview of all contemplated embodiments, and is intended to neither identify key or critical elements of all embodiments, nor delineate the scope of any or all embodiments.

The present disclosure, in one or more embodiments, relates to a crank tool having a first handle arranged on a first axis, a second handle arranged on a second axis different from the first axis, and a tooling end arranged on a third axis different from the first and second axes. The crank tool may additionally have an extension portion extending between the first and second handles. In some embodiments, the first, second, and third axes may be parallel. Moreover, the tooling end may be arranged on a tooling arm having a length of between approximately 20 inches and approximately 30 inches. The extension portion may be a first extension portion and the crank tool may include a second extension portion extending between the second handle and the tooling arm or tooling end. The first extension portion may have a length of between approximately 12 inches and approximately 24 inches and the second extension portion may have a length of between approximately 6 inches and approximately 12 inches. In some embodiments, the tooling end may include a socket head, which may be readily removable. The socket head may have an outer diameter or width of at least approximately two inches in some embodiments. Moreover, the tooling end may have a quick coupling mechanism for receiving a socket head. The tooling end may include a pivotable joint. In some embodiments of the crank tool, the third axis may be arranged between and equidistant from the first and second axes.

The present disclosure, in one or more embodiments, additionally relates to a tool system for operating trailer trap doors, the system having a hand-operated handle and a plurality of socket heads, each socket head having a recess sized and shaped to engage an attachment mechanism. The hand-operated handle may include a first handle arranged on a first axis, a second handle arranged on a second axis, and a tooling end arranged on a third axis and configured to receive a socket head. Each of the plurality of socket heads may be associated with a hopper trailer make and/or model. The attachment mechanism may be a bolt, nut, or screw. The tooling end may include a quick coupling mechanism for receiving a socket head. In some embodiments, each socket head may have an outer diameter or width of at least approximately 2 inches. In some embodiments, the hand-operated handle may include a first extension portion extending between the first handle and the second handle and a second extension portion extending between the second handle and the tooling arm. The third axis of the hand-operated handle may be arranged between and equidistant from the first and second axes. Moreover, the first second, and third axes may be parallel.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the invention will be better understood from the following description taken in conjunction with the accompanying Figures, in which:

FIG. 1 is a side view of a crank tool of the present disclosure, according to one or more embodiments.

FIG. 2 is an end view of the crank tool of FIG. 1, according to one or more embodiments.

FIG. 3 is a top view of the crank tool of FIG. 1, according to one or more embodiments.

FIG. 4 is a side view and end view of a tooling end of a crank tool having a socket head with a square shape, according to one or more embodiments.

FIG. 5 is a side view and end view of a tooling end of a crank tool having a socket head with a round and key slot recess shape, according to one or more embodiments.

FIG. 6 is a side view and end view of a tooling end of a crank tool having a knuckle joint connection, according to one or more embodiments.

FIG. 7 is a side view of a tooling end of another crank tool having a knuckle joint connection, according to one or more embodiments.

FIG. 8 is a side view of a tooling end of a crank tool having a ball joint connection, according to one or more embodiments.

### DETAILED DESCRIPTION

The present disclosure relates to novel and advantageous tools for operating trap doors, such as those arranged on lower surfaces of hopper trailers or other bottom-unloading vehicles. In particular, the present disclosure relates to novel and advantageous hand-crank tools for manually operating hopper trap doors. In some embodiments, a crank tool of the present disclosure may be used to operate a rack and pinion trap door. A crank tool of the present disclosure may have a tooling end configured to engage a bolt, nut, screw, or other mechanical component. For example, the tooling end may have a socket head. A crank tool of the present disclosure may have two handles arranged such that a user may grasp each handle with one hand. Each handle may be arranged on an axis offset from an axis of rotation of the tool, such that a user may use both of the user's arms as leverage to rotate the tool and thus rotate the bolt, nut, or screw, for example. Moreover, a crank tool of the present disclosure may be configured to reach into particularly narrow and/or otherwise hard to reach places, such as beneath a hopper trailer or other vehicle. The crank tool may additionally allow a user to operate a trap door of a hopper trailer or other bottom-unloading vehicle, for example, while standing upright or nearly upright, thus reducing the need to bend down or crouch to operate the hopper trap door.

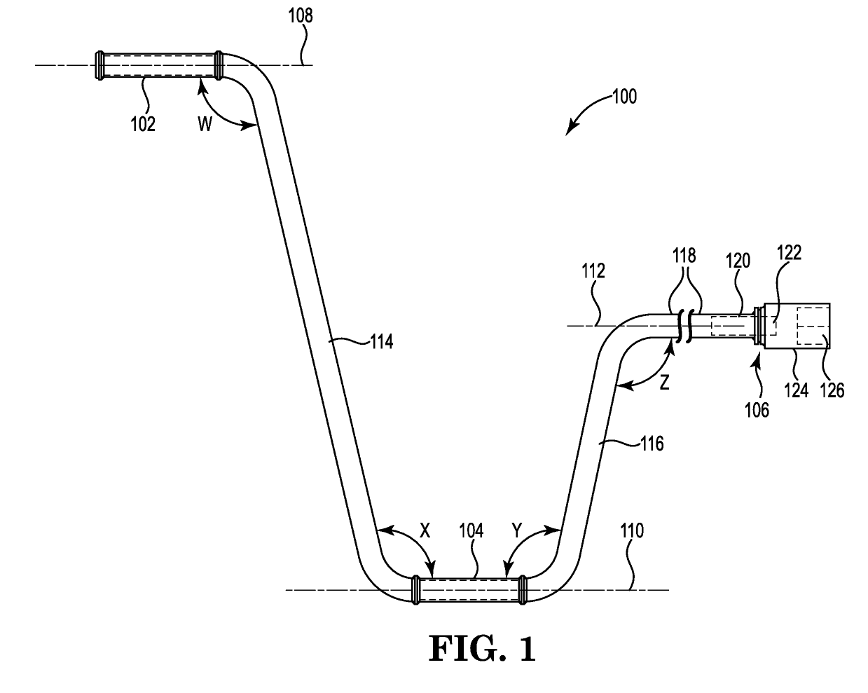

Turning now to FIG. 1, a crank tool 100, according to at least one embodiment of the present disclosure, is shown. The crank tool 100 may be configured for engaging a bolt, nut, screw, or other mechanical component of a trap door, such as on a hopper trailer. The crank tool 100 may allow a user or operator to manually rotate one or more bolts, nuts, screws, or other securing mechanisms in order to open and/or close the trap door of a hopper. The crank tool 100 may generally have a first handle 102, a second handle 104, and a tooling end 106. The tooling end 106 may be arranged on a tooling arm 118. The first handle 102 may be arranged on a first axis 108, and the second handle 104 may be arranged on a second axis 110, different from the first axis. Moreover, the tooling end 106 may be arranged on a third axis 112 different from the first 108 and second 110 axes. A first extension portion 114 may extend between the first 102 and second 104 handles. A second extension portion 116 may extend between the second handle 104 and the tooling arm 118.

The first 102 and second 104 handles may generally be configured to allow a user or operator to grip the crank tool 100 with both hands and rotate the tool about the third axis 112 by alternately rotating the handles about the third axis. The first handle 102 may be an end handle arranged at or near an end of the crank tool 100, opposing the tooling end 106. The second handle 104 may be a mid-tool handle arranged between the tooling end 106 and the first handle 102. Each handle 102, 104 may be sized and shaped to receive a user's hand, such that a user may use the handles to rotate the crank tool 100 in order to rotate a bolt, nut, screw, or other component engaged by the tooling end 106. Each handle 102, 104 may have a length of between approximately 3 inches and approximately 10 inches, or between approximately 4 inches and approximately 8 inches, or between approximately 5 inches and approximately 7 inches. Each of the handles 102, 104 may have one or more ergonomic features to allow for easier grip. In some embodiments, each of the one or more handles 102, 104 may have a rotatable cover or sheath, configured to rotate independent of the crank tool's rotation about the third axis 112. As previously indicated, the first handle 102 may be arranged on a first axis 108, the second handle 104 may be arranged on a second axis 110, and the tooling end 106 may be arranged on a third axis 112.

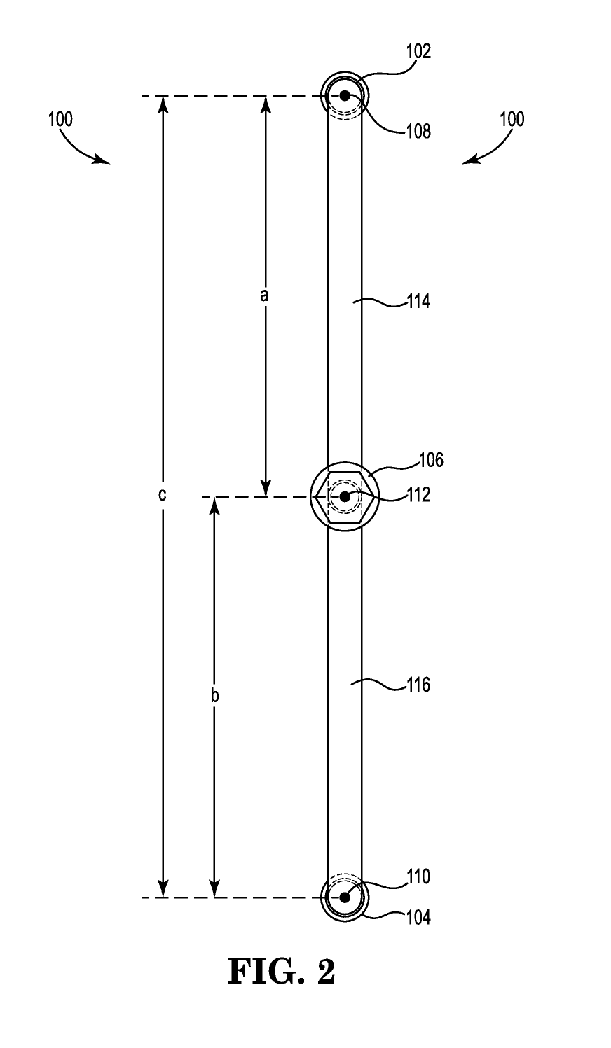

As may be appreciated with particular reference to FIGS. 1 and 2, the third axis 112 (i.e. the tooling end axis) may be arranged between the first 108 and second 110 axes. With respect to FIG. 2, it is to be appreciated that the first 108, second 110, and third 112 axes are perpendicular to the plane of the page. The third axis 112 may be an axis of rotation of the crank tool 100. The first 108, second 110, and third 112 axes may be parallel in some embodiments. As shown in FIG. 2, the first axis 108 may be separated from the third axis 112 by a distance “a” of between approximately 3 inches and approximately 24 inches, or between approximately 6 inches and 18 inches, or between approximately 8 inches and approximately 12 inches. Similarly, the second axis 110 may be separated from the third axis 112 by a distance “b” of between approximately 3 inches and approximately 24 inches, or between approximately 6 inches and approximately 18 inches, or between approximately 8 inches and approximately 12 inches. In other embodiments, each of the first axis 108 and second axis 110 may be separated from the third axis 112 by any other suitable distance. In some embodiments, each of the first 108 and second 110 axes may be equidistant from the third axis 112. Moreover, the first axis 108 and second axis 110 may be separated by a distance “c” of between approximately 6 inches and approximately 40 inches, or between approximately 12 inches and approximately 36 inches, or between approximately 16 inches and approximately 24 inches. In other embodiments, the first 108 and second 110 axes may be separated by any other suitable distance.

As indicated above, the first handle 102 and second handle 104 may be separated by a first extension portion 114. In some embodiments, the first extension portion 114 may extend between the first axis 108 and the second axis 110. In some embodiments, the first extension portion 114 may couple to each of the first 102 and second 104 handles with a rounded or curved connection, as shown for example in FIG. 1. In other embodiments, the first extension portion 114 may couple to each of the first 102 and second 104 handles with a squared or more angular connection. In some embodiments, the first extension portion 114 may couple to each of the first 102 and second 104 handles at an angle of more than 90 degrees. For example, as shown in FIG. 1, the first extension portion 114 may couple to the first handle 102 at an angle “w” of between approximately 90 degrees and approximately 135 degrees. Additionally, the first extension portion 114 may couple to the second handle 104 at an angle “x” of between approximately 90 degrees and approximately 135 degrees. In other embodiments, the first extension portion 114 may couple to the first 102 and/or second 104 handles at an angle of approximately 90 degrees, less than 90 degrees, or at any other suitable angle. The first extension portion 114 may have a length of between approximately 6 inches and approximately 36 inches, or between approximately 10 inches and approximately and approximately 30 inches, or between approximately 12 inches and approximately 24 inches. In other embodiments, the first extension portion 114 may have any other suitable length. In general, the first extension portion 114 may be sized and configured to extend a comfortable distance between a user's two hands placed on each of the first 102 and second 104 handles, such that a user may comfortably rotate the two handles about the third axis 112 while grasping the two handles in front of the user's body.

It is to be appreciated that a the first 102 and second 104 handles may be laterally offset from one another. For example, a first midline may extend orthogonal to the first axis 108, and pass through a center of the first handle 102. A second midline may extend orthogonal to the second axis 110, and pass through a center of the second handle 104. The first and second midlines may be parallel with one another, but separated by a distance. The midlines extending through the centers of the two handles 102, 104 may be separated by a distance of between approximately 6 inches and approximately 30 inches, or between approximately 10 inches and approximately 24 inches, or between approximately 12 inches and approximately 18 inches. In other embodiments, the first and second midlines may be separated by any other suitable distance.

The second handle 104 and the tooling end 106 may be separated by a second extension portion 116. In some embodiments, the second extension portion 116 may extend between the second axis 110 and the third axis 112. In some embodiments, the second extension portion 116 may couple to each of the second handle 104 and the tooling arm 118 (or tooling end 106) with a rounded or curved connection, as shown for example in FIG. 1. In other embodiments, the second extension portion 116 may couple to each of the second handle 104 and tooling arm 118 with a squared or more angular connection. In some embodiments, the second extension portion 116 may couple to each of the second handle 104 and tooling arm 118 at an angle of more than 90 degrees. For example, as shown in FIG. 1, the second extension portion 116 may couple to the second handle 104 at an angle “y” of between approximately 90 degrees and approximately 135 degrees. Additionally, the second extension portion 116 may couple to the stooling arm 118 at an angle “z” of between approximately 90 degrees and approximately 135 degrees. In other embodiments, the second extension portion 116 may couple to the second handle 104 and/or tooling arm 118 at an angle of approximately 90 degrees, less than 90 degrees, or at any other suitable angle. The second extension portion 116 may have a length of between approximately 3 inches and approximately 18 inches, or between approximately 5 inches and approximately and approximately 15 inches, or between approximately 6 inches and approximately 12 inches. In other embodiments, the second extension portion 116 may have any other suitable length. In one particular embodiment, the second extension portion 116 may have a length of approximately half the length of the first extension portion 114, as each of the first 108 and second 110 axes may be arranged approximately equidistant from the third axis 112.

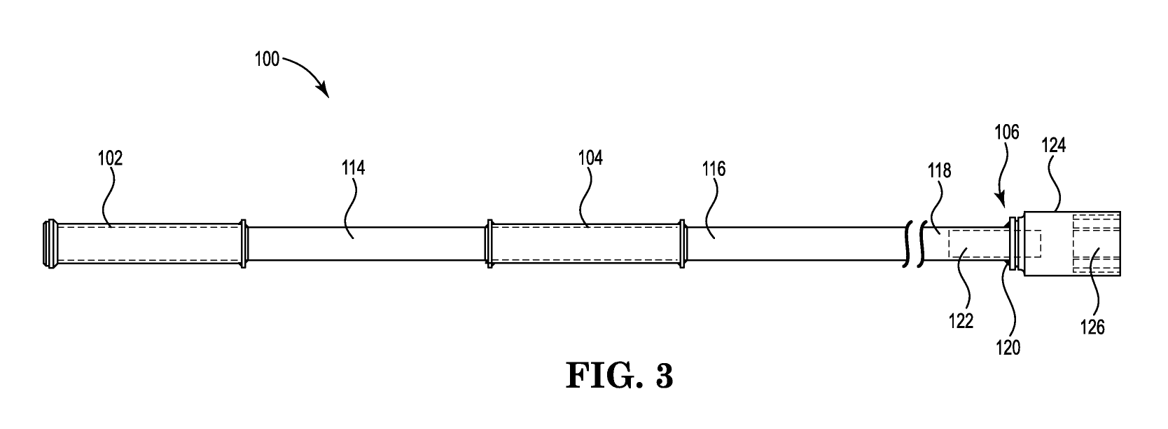

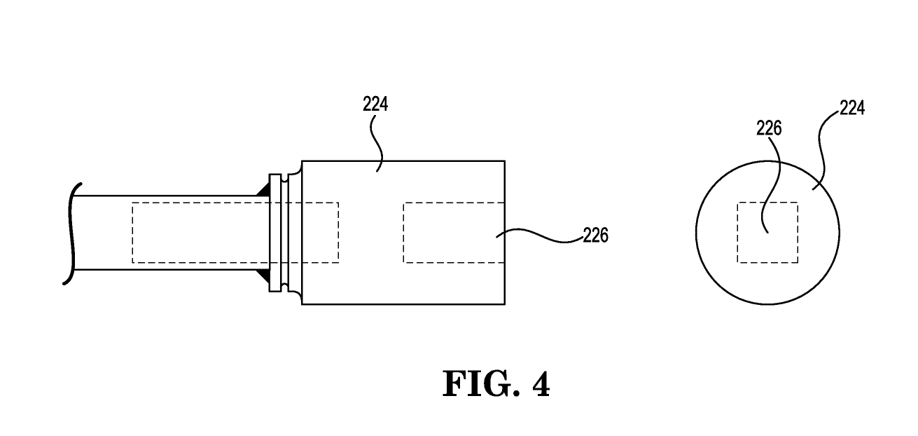

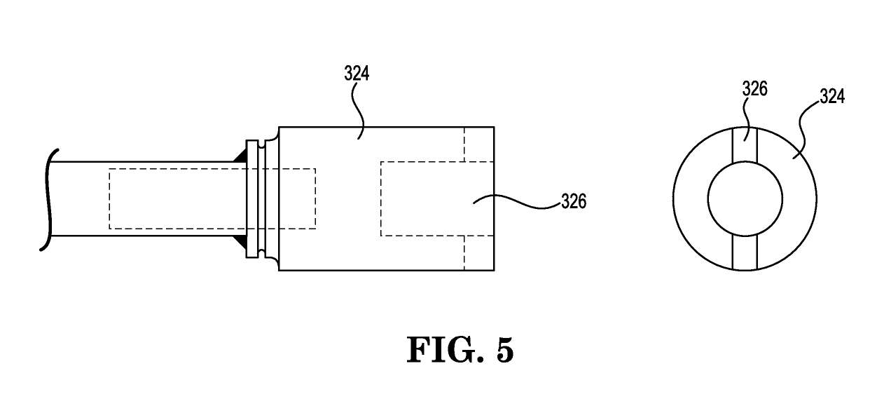

With continued reference to FIG. 1, the tooling end 106 may be configured to engage a mechanism for opening and/or closing a trap door. In some embodiments, the tooling end 106 may provide a wrench for turning a bolt, nut, or screw, for example. In some embodiments, the tooling end 106 may have a receiving portion 120 configured to receive a socket head 124. For example, an inner post 122 may extend from the receiving portion 120 and may be configured to extend into a socket head 124 or other component coupled to the receiving portion. The socket head 124 may have an opening or recess 126 sized and shaped to engage a bolt, nut, or screw. FIGS. 1 and 3 show the crank tool 100 with one embodiment of a socket head 124 having a hexagonal recess 126 configured to engage a hexagonal bolt, nut, screw, or other device. FIG. 4 shows a socket head 224 having a square recess 226 configured to engage a square-shaped bolt, nut, screw, or other device. FIG. 5 shows another socket head 324 having a round recess 326 with a key slot configured to engage a bolt, nut, screw, or other device having a similar key slot shape.

In some embodiments, a socket head 124, such as those shown in FIGS. 1 and 3, 4, or 5, may be welded or otherwise fixedly attached to the receiving portion 120. However, in other embodiments, the receiving portion 120 may be configured to receive a variety of socket heads 124 having differently sized and/or shaped recesses 126. The receiving portion 120 may have any suitable mechanism for engaging the socket head 124 such that the socket may be removably attached to the crank tool 100. For example, the receiving portion 120 may be configured to engage the socket head 124 using quick coupling, friction fit, snap fit, one or more magnets, threading, and/or any other suitable mechanism. In this way, the crank tool 100 may be useable for a variety of different trap doors or other devices, as a variety of socket heads 124 having different sized and/or shaped recesses 126 may be interchangeably attached to the receiving portion 120. In some embodiments, different socket heads 124 may be associated with different trailer makes and/or models, for example. In some embodiments, socket heads 124 may be sized and/or shaped to be caught by grating or flooring of a grain receiving hopper. For example, removable socket heads 124 configured for use with the crank tool 100 may have a length and/or diameter or width of more than approximately two inches, such that the socket heads would generally not pass through a two-inch floor grating on a grain receiving hopper. This may help mitigate losing the removable socket heads 124 if they are dropped over or near a grain receiving floor. In other embodiments, the socket heads 124 may have any other suitable dimension(s) suitable or compatible with other grate sizes.

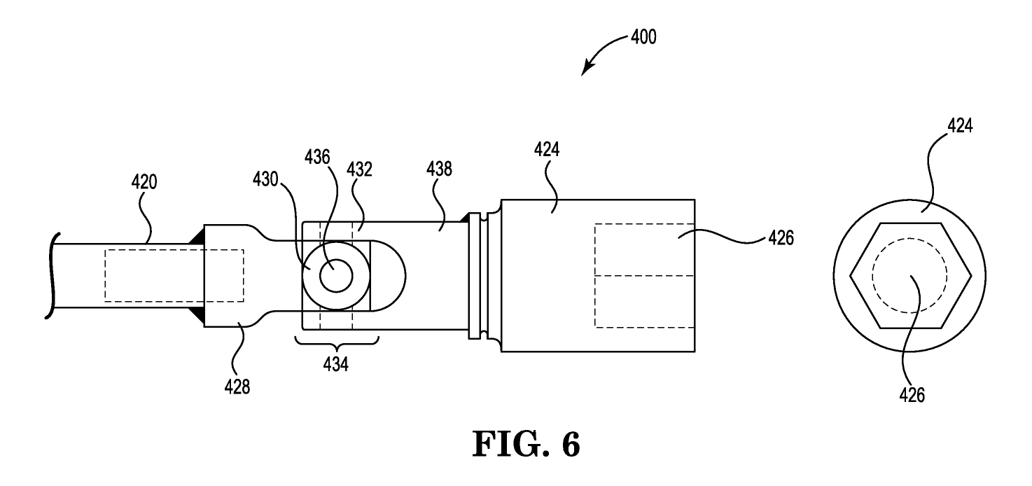

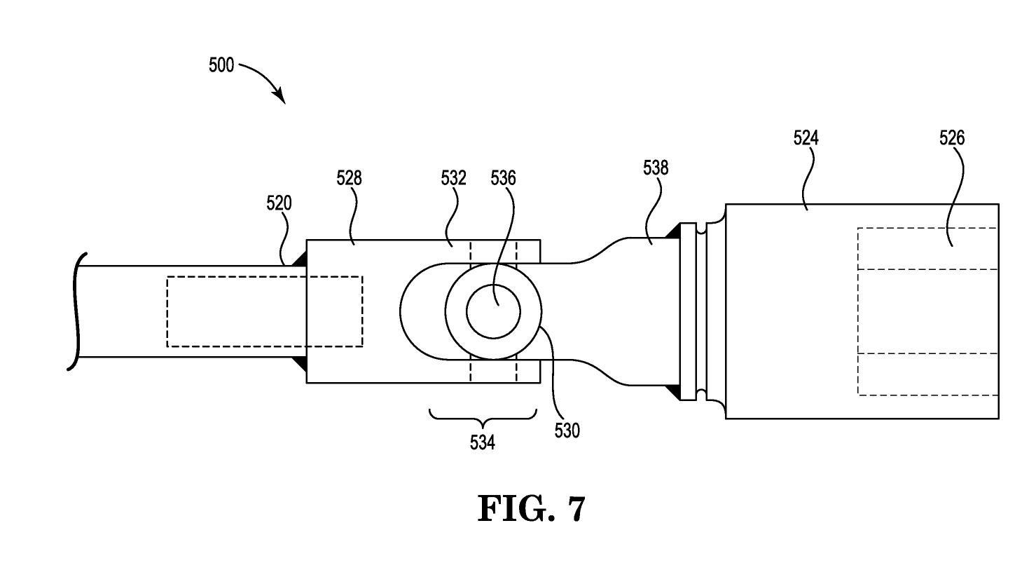

In some embodiments, the receiving portion 120 may have a joint or hinge such that socket heads 124 or other tooling devices may be pivotable with respect to the crank tool 100. For example, FIG. 6 shows one embodiment of a crank tool 400 having a jointed connection to a socket head 424. A receiving portion 420 of the crank tool 400 may have an attachment component 428 providing an eye end 430 for engaging with a fork end 432 to form a knuckle joint 434. For example, the attachment component 428 may be welded or otherwise fixedly or removably attached to the receiving portion 420. The eye end 430 may have an opening 436 for receiving a pin. A socket head 424 may be arranged on a socket component 438 having a fork end 432. The socket head 424 may have any suitably sized and shaped recess 426, as described above. The fork end 432 may have two prongs configured to receive the eye end 430 therebetween to form the knuckle joint 434. Each prong may have an opening configured to receive a pin. However, it is to be appreciated that in some embodiments, the eye end 430 and fork end 432 of the knuckle joint 434 may be alternatively arranged on the opposing components. As shown in FIG. 7, for example, an eye end 530 may be arranged on the socket component 538, and a fork end 532 may be arranged on an attachment component 528 of the receiving portion 520. In this way, the socket head 524 may be configured to pivot about the knuckle joint 534. In general, knuckle joints or other pivotable joints may allow an operator or user to more easily access some trap door configurations. For example, the ability to pivot the socket head may allow an operator to engage a bolt, nut, screw, or other component without excessive bending or reaching.

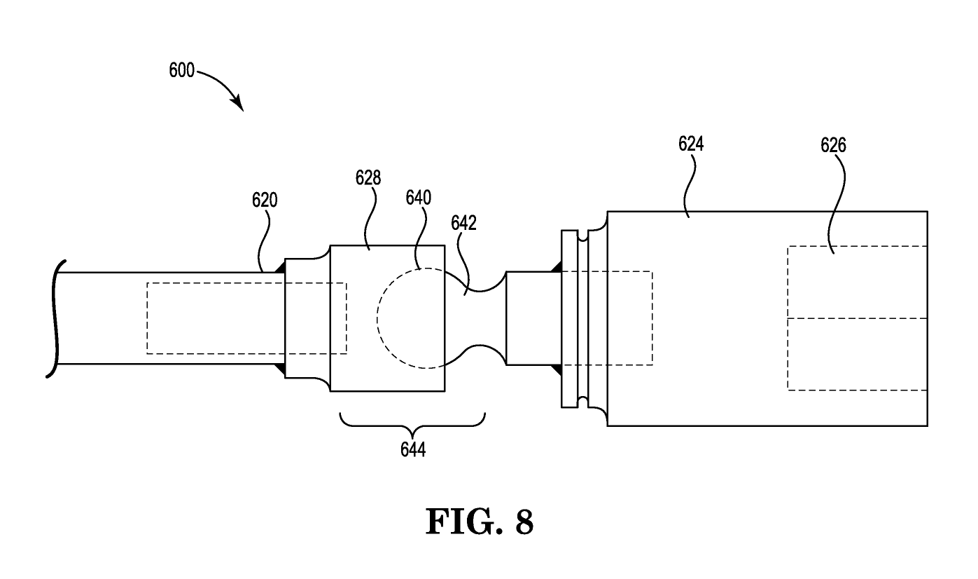

In other embodiments, other jointed or hinged connections may be used between the crank tool and the socket head. For example, FIG. 8 shows an embodiment of a crank tool 600 having an alternative jointed connection. As shown, an attachment component 628 having an opening or recess 640 for receiving a ball stud 642 may be coupled to the receiving portion 620. A socket head 624 may be arranged on or affixed to a ball stud 642 configured to engage with the recess 640 of the attachment portion 628 to form a ball joint connection 644. The ball joint connection 644, or a similar connection, may allow the socket head 624 to be pivoted in generally any direction with respect to the crank tool 600. This may allow an operator or user to more easily access some trap door configurations. In still other embodiments, other jointed or hinged connection mechanisms may be used to provide for rotation of the socket head or other tooling components about the crank tool.

With reference back to FIG. 1, in some embodiments, the tooling end 106 may be arranged on a tooling arm 118. The tooling arm 118 may extend from the second extension portion 116. In some embodiments, the tooling arm 118 may be arranged, together with the tooling end 106, along the third axis 112. The tooling arm 118 may have a length configured to allow an operator or user to more easily reach a bolt, nut, screw, or other mechanism securing a trap door, such as on a hopper trailer or other bottom-unloading vehicle. In some embodiments, the tooling arm 118 may have a length of between approximately 5 inches and approximately 50 inches. In particular, the tooling arm 118 may have a length of between approximately 10 inches and approximately 40 inches, or between approximately 20 inches and approximately 30 inches. In other embodiments, the tooling arm 118 may have any other suitable length. The tooling arm 118 may have a relatively narrow diameter or width in some embodiments, so as to allow the tool 100 to pass through relatively narrow spaces. For example, the tooling arm 118 may have a diameter or width of between approximately 0.25 inches and approximately 2 inches, or between approximately 0.5 inches and approximately 1 inch. In other embodiments, the tooling arm 118 may have any other suitable width or diameter.

The crank tool 100 may generally be constructed of steel, aluminum, or any other metal or combination of metals. That is, the first handle 102, first extension portion 114, second handle 104, second extension portion 116, tooling arm 118, and/or socket head 124 may be constructed of one or more metals. The handles 102, 104, extension portions 114, 116, and tooling arm 118 may be constructed of a single metal rod in some embodiments, the metal rod having bends at suitable angles to form the different components. For example, a metal rod may have a first bend between the first handle 102 and first extension portion 114, a second bend between the first extension portion and the second handle 104, a third bend between the second handle and second extension portion 116, and a fourth bend between the second extension portion and tooling arm 118. The metal rod may have a diameter of between approximately 0.25 inches and approximately 2 inches, or between approximately 0.5 inches and approximately 1 inch. In other embodiments, the metal rod may have any other suitable diameter. In some embodiments, the crank tool 100 may be constructed of one or more rigid plastics. For example, a single plastic rod having bends at suitable angles, as described above with respect to the metal rod, may provide the handles 102, 104, extension portions 114, 116, and tooling arm 118.

In use, a crank tool of the present disclosure may allow a user or operator to manually operate a bolt, nut, screw, or other component. In particular, the crank tool may be used to manually operate a trap door, such as on a lower surface of a hopper trailer or other bottom-unloading vehicle. In particular, the crank tool may allow a user to reach a bolt, nut, screw, or other mechanism arranged in a partially obstructed or otherwise hard to reach location. For example, the relatively long length of the tool may provide a relatively long reach. Similarly, the narrow diameter or width of the tooling arm may allow for maneuverability of the tool into relatively small spaces. The arrangement of the two handles may allow an operator to use the leverage of both of the operator's arms to operate the tool. In this way, with one hand on each of the two handles, an operator may rotate his or her arms in a same direction to rotate the tool about the third axis (i.e. the tooling axis). With each of the two handles offset from the third axis, each handle may provide a lever for rotating the tool. In this way, the operator may thus use leverage of both arms in conjunction to rotate the tool. As described above, the handles may be generally arranged to allow an operator to comfortably grasp both handles and rotate his or her arms. The arrangement of the two handles may allow an operator to apply torque to a bolt, nut, screw, or other component with both arms. By allowing a user to apply torque with both arms, the crank tool may decrease the amount of effort or strength needed to open a trap door using other manual tools. In turn, this may allow an operator to operate a hopper trap door in less time than with other manual tools. Moreover, the arrangement of the handles and the angles and lengths of the extension portions may allow an operator to operate a trap door of a hopper trailer or other bottom-unloading vehicle, for example, without having to bend low to the ground. That is, an operator may be able to stand upright or nearly upright while using the crank tool to open a hopper trailer trap door, so as to alleviate strain on the operator's back and/or knees.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of” or “generally free of” an element may still actually contain such element as long as there is generally no significant effect thereof.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

Additionally, as used herein, the phrase “at least one of [X] and [Y],” where X and Y are different components that may be included in an embodiment of the present disclosure, means that the embodiment could include component X without component Y, the embodiment could include the component Y without component X, or the embodiment could include both components X and Y. Similarly, when used with respect to three or more components, such as “at least one of [X], [Y], and [Z],” the phrase means that the embodiment could include any one of the three or more components, any combination or sub-combination of any of the components, or all of the components.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

What is claimed is:

1. A crank tool comprising:
a first handle arranged on a first axis;
a second handle arranged on a second axis different from the first axis;
an extension portion extending between the first handle and the second handle; and
a tooling end arranged on a third axis, the third axis different from the first and second axes;
wherein the first, second, and third axes are parallel.

2. The crank tool of claim 1, wherein the tooling end is arranged on a tooling arm.

3. The crank tool of claim 2, wherein the tooling arm has a length of between approximately 20 inches and approximately 30 inches.

4. The crank tool of claim 2 wherein the extension portion is a first extension portion, and the crank tool further comprises a second extension portion extending between the second handle and the tooling arm.

5. The crank tool of claim 1 wherein the extension portion is a first extension portion, and the crank tool further comprises a second extension portion extending between the second handle and the tooling end.

6. The crank tool of claim 5, wherein the first extension portion has a length of between approximately 12 inches and approximately 24 inches, and wherein the second extension portion has a length of between approximately 6 inches and approximately 12 inches.

7. The crank tool of claim 1, wherein the tooling end comprises a socket head.

8. The crank tool of claim 7, wherein the socket head is readily removable.

9. The crank tool of claim 7, wherein the socket head comprises an outer diameter or width of at least approximately two inches.

10. The crank tool of claim 1, wherein the tooling end comprises a quick coupling mechanism for receiving a socket head.

11. The crank tool of claim 1, wherein the tooling end comprises a pivotable joint.

12. The crank tool of claim 1, wherein the third axis is arranged between, and equidistant from, the first and second axes.

13. A tool system for operating trailer trap doors, the system comprising:
a hand-operated handle comprising:
a first handle arranged on a first axis;
a second handle arranged on a second axis; and
a tooling end arranged on a third axis and configured to receive a socket head; and
a plurality of socket heads, each socket head having a recess sized and shaped to engage an attachment mechanism.

14. The tool system of claim 13, wherein each of the plurality of socket heads is associated with a hopper trailer make and/or model.

15. The tool system of claim 13, wherein the attachment mechanism is a bolt, nut, or screw.

16. The tool system of claim 13, wherein the tooling end comprises a quick coupling mechanism for receiving a socket head.

17. The tool system of claim 13, wherein each socket head comprises an outer diameter or width of at least approximately two inches.

18. The tool system of claim 13, wherein the hand-operated handle additionally comprises a first extension portion extending between the first handle and the second handle and a second extension portion extending between the second handle and the tooling arm.

19. The tool system of claim 13, wherein the third axis is arranged between, and equidistant from, the first and second axes.

20. The tool system of claim 13, wherein the first, second, and third axes are parallel.
